(19) United States
(12) Patent Application Publication
(10) Pub. No.: US 2008/0303994 A1
(43) Pub. Date: Dec. 11, 2008

(54) HYBRID DISPLAY

(75) Inventors: Shie-Chang Jeng, Pingtung County (TW); Kang-Hung Liu, Hsinchu County (TW); Chi-Chang Liao, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/195,402

(22) Filed: Aug. 20, 2008

Related U.S. Application Data
(62) Division of application No. 11/308,881, filed on May 22, 2006.

(30) Foreign Application Priority Data
Feb. 17, 2006 (TW) 95105358

(51) Int. Cl. G02F 1/1335

(52) U.S. Cl. 349/114

(57) ABSTRACT

A hybrid display capable of operating under any ambient illumination. The hybrid display includes a reflective substrate, a plurality of self-emissive units and a plurality of reflective light valves. The reflective substrate has a first surface and a second surface. The self-emissive display units are arranged to form an array on the first surface of the reflective substrate and the reflective light valves are arranged to form an array on the second surface of the reflective substrate. Furthermore, the reflective light valves are suitable for modulating the reflectivity of ambient light.

### CROSS-REFERENCE TO RELATED APPLICATION

This application is a divisional application of U.S. application Ser. No. 11/308,881 filed on May 22, 2006, which claims the priority benefit of Taiwan application serial no. 95105358, filed on Feb. 17, 2006. All disclosure of the Taiwan application is incorporated herein by reference.

### BACKGROUND OF THE INVENTION

1. Field of the Invention

The present invention relates to a hybrid display, more particularly, a hybrid display capable of operating under any ambient illumination.

2. Description of Related Art

The rapid development of semiconductor production technologies and man-machine interface devices has led to a significant growth in the use of multi-media. Due to the high display quality and economy, cathode ray tube (CRT) has dominated the market of display devices for quite some time. However, the bulk and the power consumption of a CRT have created a number of problems. As a result, liquid crystal display, with its high picture quality, good spatial utilization, low power consumption and radiation-free operation, has become one of the mainstream products in the market.

Generally, liquid crystal displays can be classified into three major types, namely, the transmissive type, the reflective type and the transflective type. This classification is based on the utilization of the light source and the difference in the array substrate. The transmissive liquid crystal display uses a backlight unit as the light source and the pixel electrodes on the array substrate are transparent to facilitate the passage of light from the backlight unit. The reflective liquid crystal display mainly uses a front light source or ambient light as the light source. The pixel electrodes on the array substrate are metallic electrodes or other reflective electrodes with a good reflecting property suitable for reflecting light from the front light source or the ambient light. The transflective liquid crystal display can simultaneously use the light from a backlight unit and the ambient light to illuminate the display. The pixels on the transflective liquid crystal display include a transparent region and a reflective region. The transparent region has transparent electrodes to facilitate the passage of light from a backlight source and the reflective region has reflective electrodes suitable for reflecting ambient light.

The foregoing transmissive liquid crystal display mostly operates in an indoor environment. If the transmissive liquid crystal display is brought into an outdoor environment, the strong outdoor light will wash out the display image. On the contrary, there is no such problem for using a reflective LCD in an outdoor environment. Since the reflective liquid crystal display requires no backlight source, it has relatively low power consumption. However, from the foregoing discussion, both the transmissive liquid crystal display and the reflective liquid crystal display are not suitable for operating under all ambient illumination conditions. Therefore, the transflective liquid crystal display capable of operating both in an indoor environment as well as an outdoor environment has been proposed. Yet, the transflective liquid crystal display still requires a backlight source, and, hence, there is still room for improving the power consumption of the transflective liquid crystal display.

### SUMMARY OF THE INVENTION

Accordingly, the present invention is to provide a hybrid display capable of operating under any ambient illumination and having a dual side displaying capacity.

The present invention provides an alternative hybrid display capable of operating under any ambient illumination. The hybrid display includes a reflective substrate, a plurality of self-emissive units and a plurality of reflective light valves. The reflective substrate has a first surface and a second surface. The self-emissive display units are arranged to form an array on the first surface of the reflective substrate and the reflective light valves are arranged to form an array on the second surface of the reflective substrate. Furthermore, the reflective light valves are suitable for modulating the reflectivity of ambient light.

In one embodiment of the present invention, the foregoing self-emissive display unit includes an electro-luminescence display unit.

In one embodiment of the present invention, the foregoing reflective light valve includes a liquid crystal display unit, an electro-wetting display unit or an electrophoresis display unit, for example.

Since the hybrid display in the present invention has transmissive light valves or reflective light valves capable of utilizing the ambient light, there is no need to install a backlight unit. As a result, the manufacturing cost and the power consumption are reduced and the hybrid display is lighter and less bulky.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C are schematic cross-sectional views of hybrid displays according to the first embodiment of the present invention.

FIGS. 2A through 2C and FIGS. 2A′ through 2C′ are schematic cross-sectional views of hybrid displays according to the second embodiment of the present invention.

FIG. 3A through 3C are schematic cross-sectional views of hybrid displays according to the third embodiment of the present invention.

FIGS. 4A through 4C and FIGS. 4A′ through 4C′ are schematic cross-sectional views of hybrid displays according to the fourth embodiment of the present invention.

FIG. 5 is a schematic cross-sectional view of a hybrid display according to the fifth embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

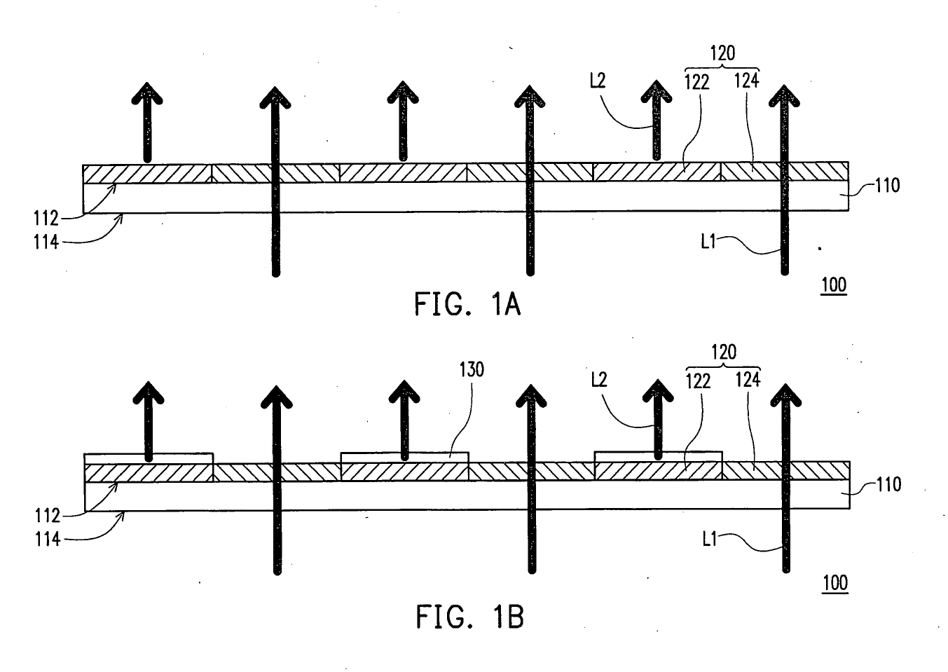

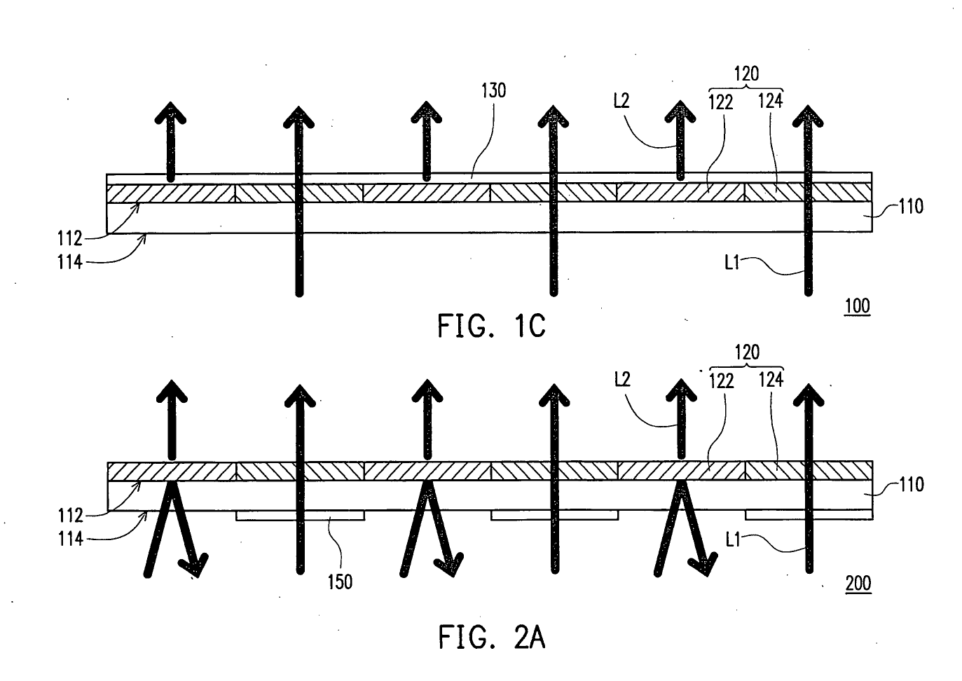

FIGS. 1A through 1C are schematic cross-sectional views of hybrid displays according to the first embodiment of the present invention. As shown in FIG. 1A, the hybrid display 100 in the present embodiment includes a transparent substrate 110 and a plurality of pixels 120 arranged in an array on the transparent substrate 110. Each of the pixels 120 includes a self-emissive display unit 122 and a transmissive light valve 124. The transmissive light valve 124 is suitable for modulating the transmittance of ambient light L1 entering from one side of the transparent substrate 110. It should be noted that the self-emissive display unit 122 can be an electro-luminescence display unit (for example, an organic electroluminescence display unit) or other self-emissive type of display unit. The transmissive light valve 124 can be any general non self-emissive display unit that requires an ambient light source and permits the passage of ambient light rays. In the present embodiment, the self-emissive display unit 122 is a top emission electro-luminescence display unit and the transmissive light valve 124 is a liquid crystal display unit, an electro-wetting display unit or an electrophoresis display unit, for example.

According to FIG. 1A, the transparent substrate 110 has a first surface 112 back facing the ambient light L1 and a second surface 114 facing the ambient light L1. Furthermore, the self-emissive display units 122 and the transmissive light valves 124 are both disposed on the first surface 112 back facing the ambient light L1. Since the self-emissive display units 122 are top emission electro-luminescence display units and the light rays L2 from the top emission electro-luminescence display units travel in a direction away from the transparent substrate 110, a user can view the image from a side location adjacent to the first surface 112. More specifically, a reflective layer or a reflective electrode can be used inside each of the top emission electro-luminescence display units so that most of the light rays from the top emission electro-luminescence display units travel in a direction away from the transparent substrate 110. It should be noted that the reflective layer or the reflective electrode in the self-emissive display unit 122 could reflect the ambient light L1 incident on the second surface 114 of the transparent substrate 110. Therefore, the reflective layer or the reflective electrode can provide some additional contrast ratio to the image displayed by the self-emissive display device 122.

As described, the self-emissive display units 122 arranged in an array on the transparent substrate 110 and the transmissive light valves 124 are driven by different scan lines and data lines so that the self-emissive display units 122 and the transmissive light valves 124 can display images under a varying environment. More specifically, when the hybrid display 100 is located in an outdoor environment or other environment with strong ambient illumination, the transmissive light valves 124 may utilize the ambient light L1 as a backlight source to achieve the goal of displaying an image. Thus, the self-emissive display units 122 may remain in a non-driven state. When the hybrid display 100 is located in an indoor environment or other dark environment, the self-emissive display unit 122 may be used to display a high-quality image. Since the ambient light L1 that can be utilized by the transmissive light valve 124 is quite limited, the transmissive light valve 124 will remain in a non-driven state.

In the foregoing example, the self-emissive display units 122 and the transmissive light valves 124 will not display images simultaneously. However, the driving method of the hybrid display 100 in the present invention is not limited thereto. In other words, the self-emissive display units 122 and the transmissive light valve 124 in the hybrid display 100 may display images simultaneously to provide a better display quality. The hybrid display 100 in the present invention detects the state of the environmental through a sensor and decides on which operating mode is to be performed according to the result (whether only the self-emissive display units 122 are displayed, only the transmissive light valves 124 are displayed, or both the self-emissive display units 122 and the transmissive light valves 124 are displayed simultaneously).

As shown in FIGS. 1B and 1C, the reflective layer or the reflective electrode in the self-emissive display units 122 can reflect the ambient light incident on the self-emissive display units 122. Therefore, the reflective layer or the reflective electrode in the self-emissive display units 122 will degrade the quality of the image displayed by the self-emissive display units 122 due to ambient light interference. To improve the display quality, the hybrid display 100 in the present embodiment may further include a polarizer and/or a retardation film 130. In the present embodiment, the polarizer and/or retardation film 130 are distributed only on the self-emissive display units 122 (as shown in FIG. 1B) to improve the display quality of the self-emissive display units 122. Obviously, the polarizer and/or the retardation film 130 may be distributed both on the self-emissive display units 122 and the transmissive light valves 124 (as shown in FIG. 1C). In one preferred embodiment, the retardation film is a quarter wave plate or other optical film having a different retardation, for example.

### Second Embodiment

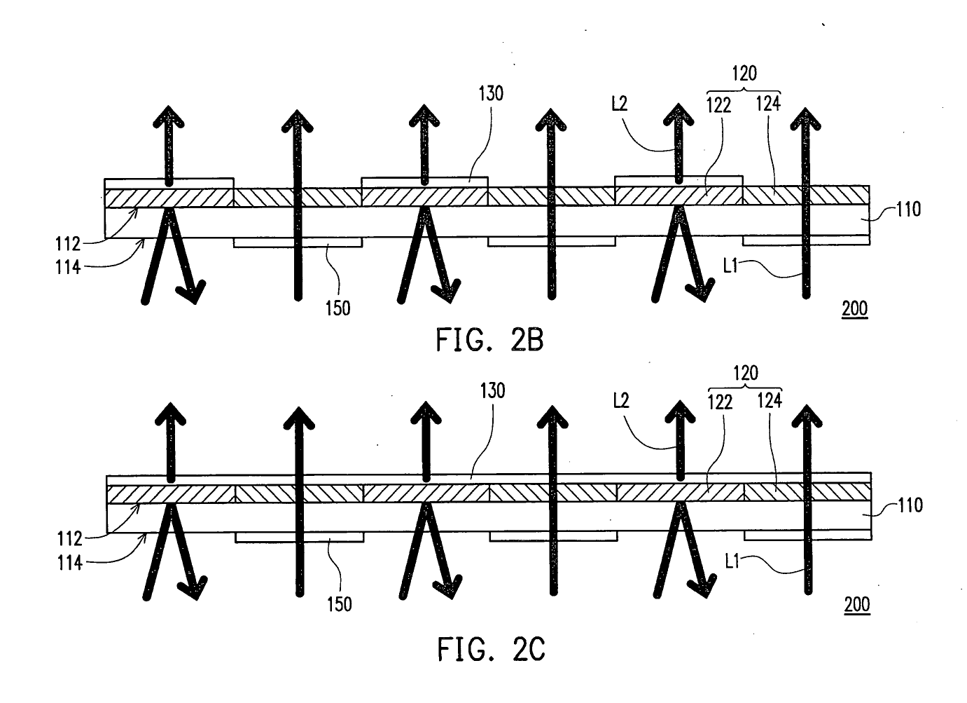

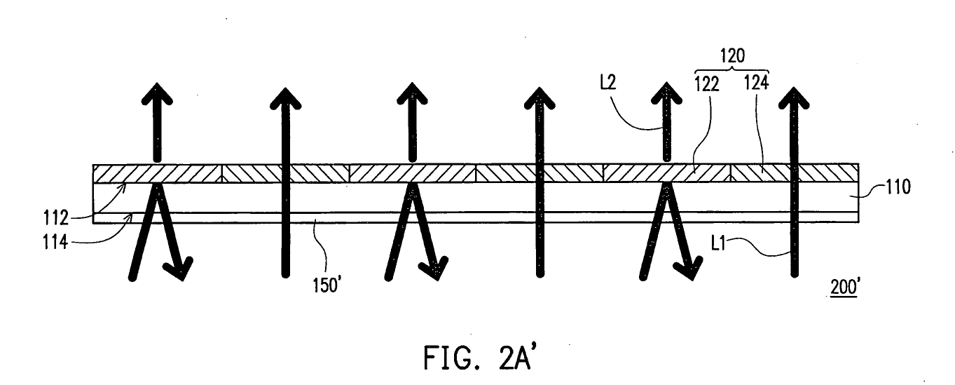

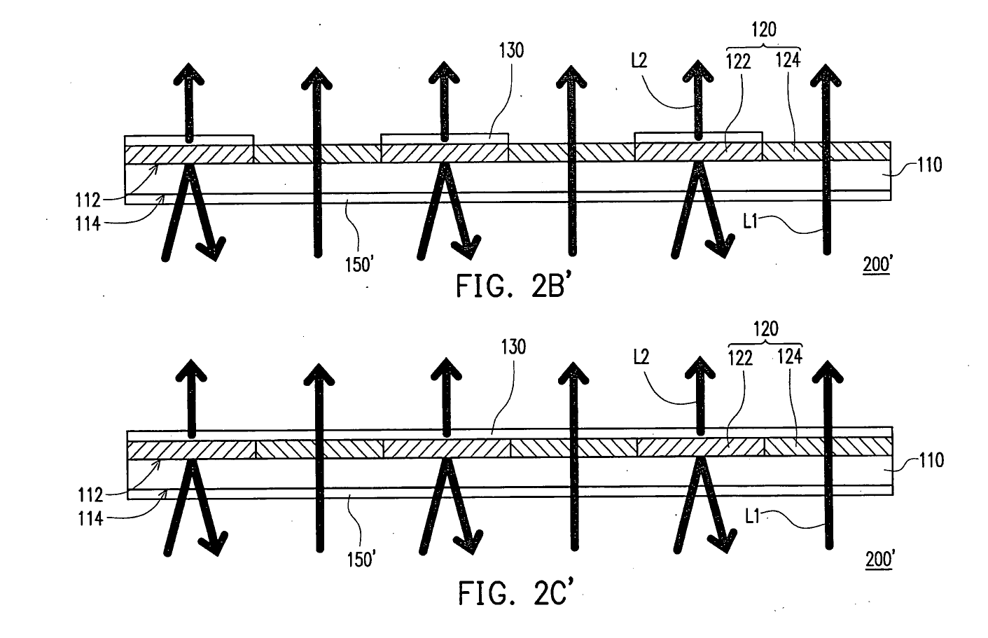

FIGS. 2A through 2C and FIGS. 2A′ through 2C′ are schematic cross-sectional views of hybrid displays according to the second embodiment of the present invention. As shown in FIGS. 2A through 2C, the hybrid display 200 in the present embodiment is very similar to the hybrid display 100 in the first embodiment (FIGS. 1A through 1C). One major difference is that the hybrid display 200 in FIGS. 2A through 2C further includes an optical film 150 disposed on the second surface 114 of the transparent substrate 110. The optical film 150 is disposed in locations that correspond to the transmissive light valves 124. To provide a better display quality, the optical film 150 may be a diffusion plate, a prism sheet (capable of collimating the incident ambient light), a polarizer, a retardation film or any combination of the foregoing film plates, for example.

As shown in FIGS. 2A′ through 2C′, the hybrid display 200′ is very similar to the hybrid display 200 shown in FIGS. 2A through 2C. The main difference is that the optical film 150′ in the hybrid display 200′ are disposed on both of the self-emissive display unit 122 and the transmissive light valves 124. In the present embodiment, the retardation film is a quarter wave plate or other optical film having a different retardation.

### Third Embodiment

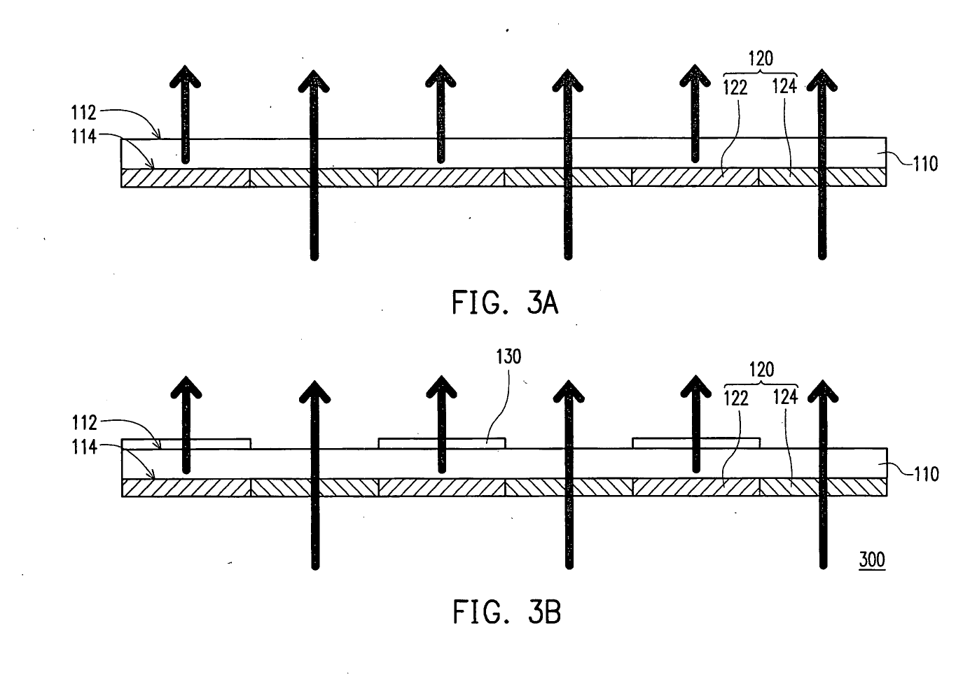

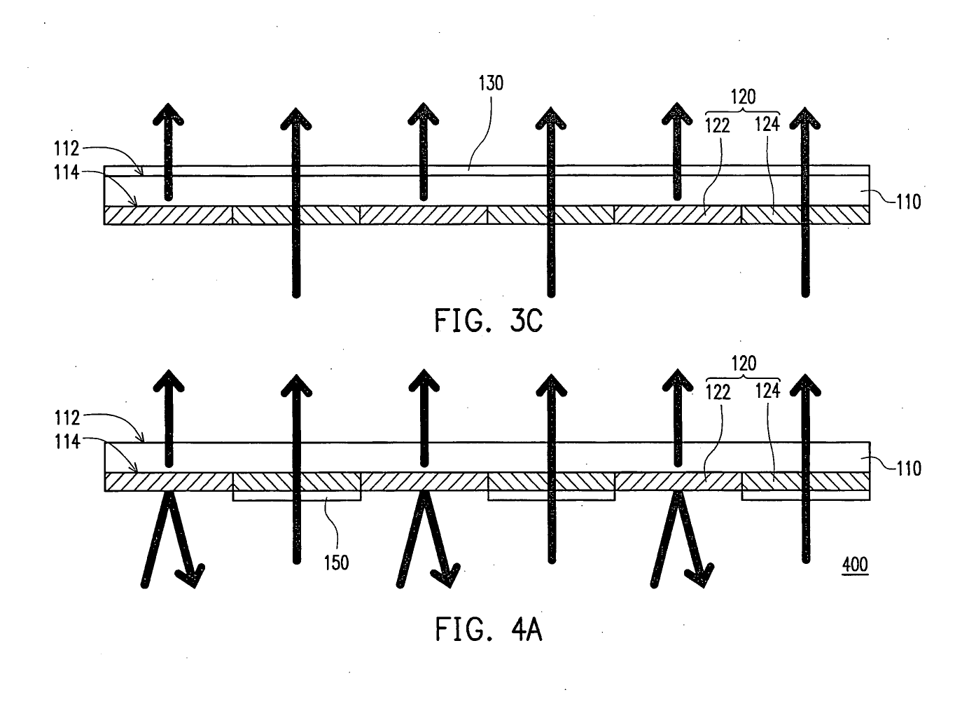

FIG. 3A through 3C are schematic cross-sectional views of hybrid displays according to the third embodiment of the present invention. As shown in FIGS. 3A through 3C, the hybrid display 300 is very similar to the hybrid display 100 in the first embodiment (FIGS. 1A through 1C). The main difference is that both the self-emissive display units 122 and the transmissive light valves 124 are disposed on the second surface 114 of the transparent substrate 100. Furthermore, the self-emissive display units 122 are bottom emission electro-luminescence display units.

As shown in FIGS. 3A through 3C, the self-emissive display units 122 are bottom emission electro-luminescence display units. Furthermore, the light rays L2 emitted from the bottom emission electro-luminescence display units will penetrate through the transparent substrate 110. Thus, a user may view the image from a side location adjacent to the first surface 112. More specifically, a reflective layer or a reflective electrode may be used in each of the bottom emission electro-luminescence display units so that most of the light rays from the bottom emission electro-luminescence display units can penetrate through the transparent substrate 110.

The reflective layer or the reflective electrode in the self-emissive display units 122 can reflect the ambient light incident on the self-emissive display units 122. Therefore, the reflective layer or the reflective electrode in the self-emissive display units 122 will degrade the quality of the image displayed by the self-emissive display units 122 due to ambient light interference. To improve the display quality, a polarizer and/or retardation film 130 is disposed on the first surface 112 of the transparent substrate 110 of the hybrid display 300 (as shown in FIG. 3B) in the present embodiment. Furthermore, the polarizer and/or the retardation film 130 is disposed in locations that correspond to the self-emissive display units 122. In the present embodiment, the polarizer and/or retardation film 130 is distributed only on the self-emissive display units 122 (as shown in FIG. 3B) to improve the display quality of the self-emissive display units 122. Obviously, the polarizer and/or the retardation film 130 may be distributed on both of the self-emissive display units 122 and the transmissive light valves 124 (as shown in FIG. 3C). In one preferred embodiment, the retardation film is a quarter wave plate or other optical film having a different retardation, for example.

### Fourth Embodiment

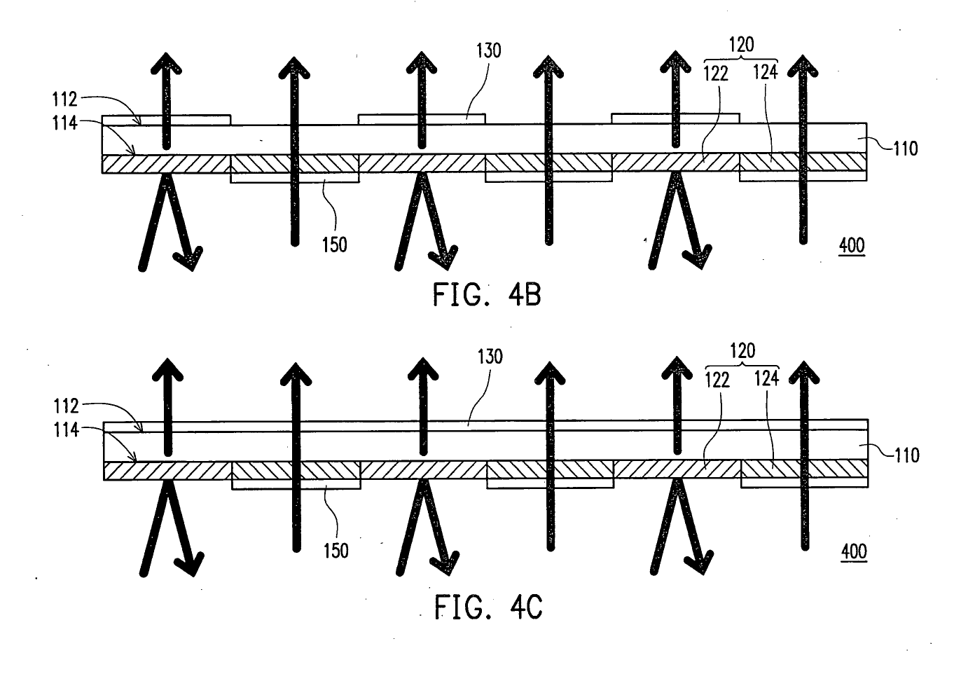

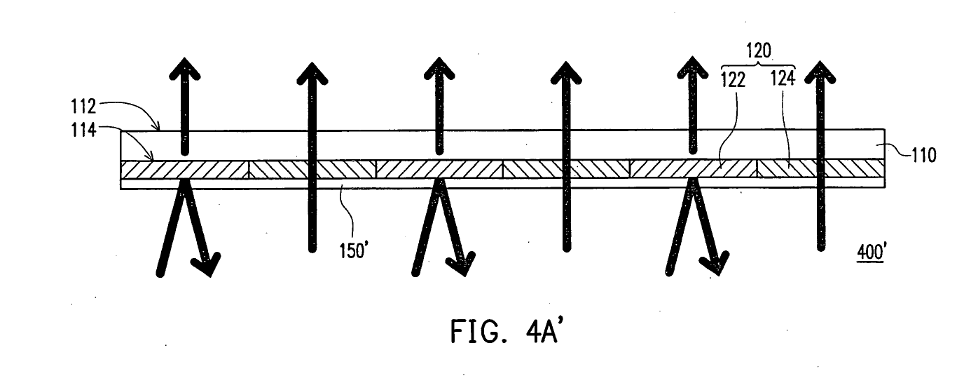

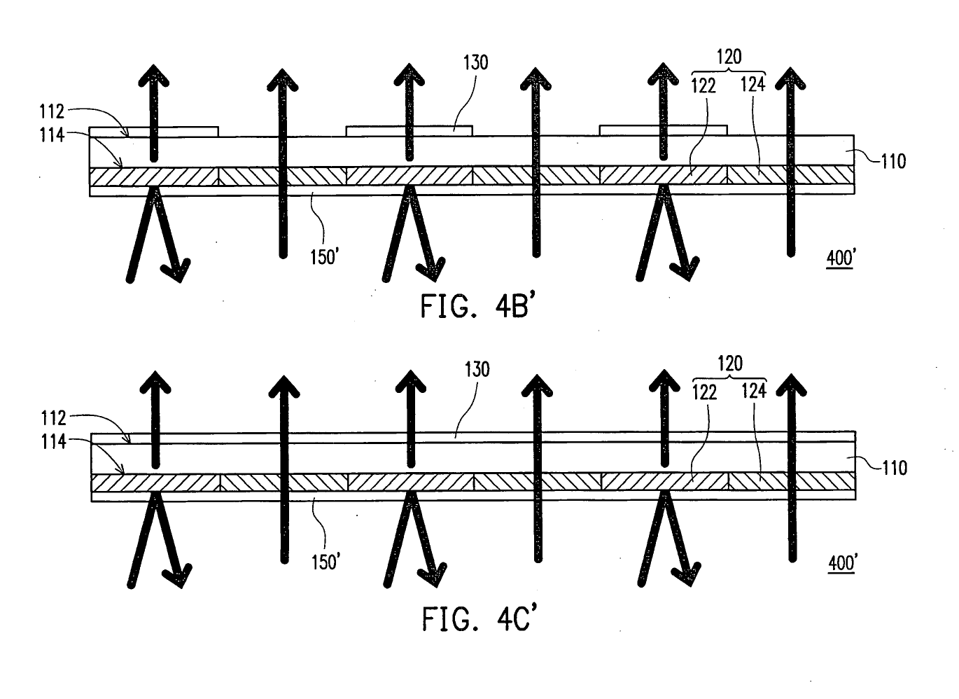

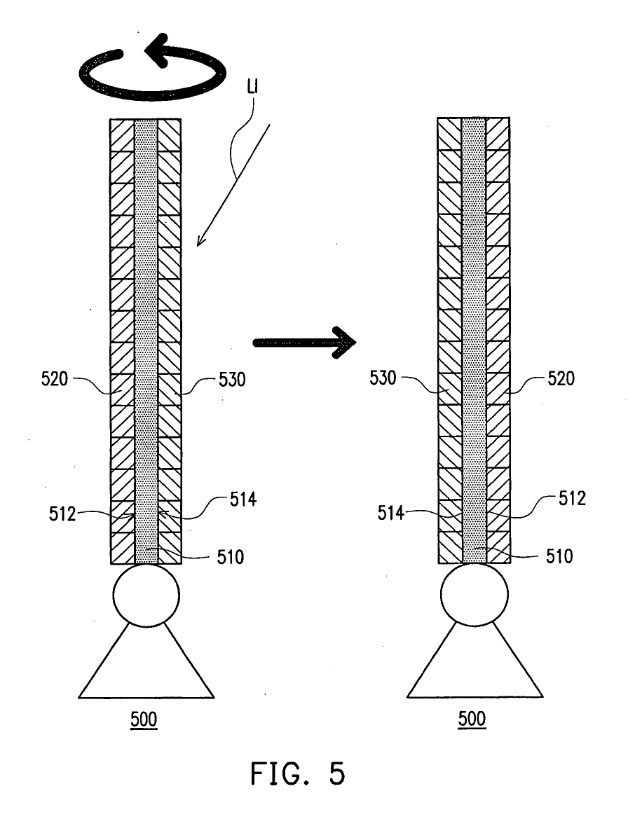

FIGS. 4A through 4C and FIGS. 4A′ through 4C′ are schematic cross-sectional views of hybrid displays according to the fourth embodiment of the present invention. As shown in FIGS. 4A through 4C, the hybrid display 400 in the present embodiment is very similar to the hybrid display 300 in the third embodiment (as shown in FIGS. 3A through 3C). The main difference is that the hybrid display 400 in FIGS. 4A through 4C further includes an optical film 150 disposed on the transmissive light valves 124. To provide a better display quality, the optical film 150 may be a diffusion plate, a prism sheet (capable of collimating ambient light), a polarizer, a retardation film or any combination of the foregoing film plates, for example.

As shown in FIGS. 4A′ through 4C′, the hybrid display 400′ is very similar to the hybrid display 400 in FIGS. 4A through 4C. The main difference is that the optical film 150′ in the hybrid display 400′ is distributed on both of the self-emissive display units 122 and the transmissive light valve 124. In the present embodiment, the retardation film is a quarter wave plate or other optical film having a different retardation, for example.

### Fifth Embodiment

FIG. 5 is a schematic cross-sectional view of a hybrid display according to the fifth embodiment of the present invention. As shown in FIG. 5, the hybrid display 500 in the present embodiment includes a reflective substrate 510, a plurality of self-emissive display units 520 and a plurality of reflective light valves 530. The reflective substrate 510 has a first surface 512 and a second surface 514. The self-emissive display units 520 are arranged to form an array on the first surface 512 of the reflective substrate 510 and the reflective light valves 530 are arranged to form an array on the second surface 514 of the reflective substrate 510. Furthermore, the reflective light valves 530 are suitable for modulating the transmittance of ambient light L1. In one preferred embodiment, the self-emissive display units 520 are electro-luminescence display units and the reflective light valves 530 are liquid crystal display units, electro-wetting display units or electrophoresis display units, for example.

In the present embodiment, a user may select to use either side of the self-emissive display units 520 and the reflective light valves 530 according to the ambient environment. In other words, when the hybrid display 500 is located in an outdoor environment or other environment with strong ambient illumination, the reflective light valves 530 can utilize the ambient light L1 to achieve the goal of displaying a good image. Thus, the self-emissive display unit 520 remains in a non-driven state. When the hybrid display 500 is located in an indoor environment or dark environment, the self-emissive display unit 520 can display a high-quality image. Because the utilization of ambient light L1 by the reflective light valves 530 is quite limited, the reflective light valves 530 remains in a non-driven state.

In summary, the hybrid display in the present invention has at least the following advantages:

1. The hybrid display in the present invention combines the capability of the transmissive light valves for utilizing ambient light and the self-emissive display units. Therefore, the hybrid display of the present invention can be used under any environmental illumination (indoors or outdoors).

2. The hybrid display of the present invention combines the capability of the reflective light valves for utilizing ambient light and the self-emissive display units. Therefore, the hybrid display of the present invention can be used under any environmental illumination (indoors or outdoors).

3. Since the hybrid display in the present invention does not require a backlight source, the hybrid display has lower power consumption than conventional transflective LCD.

4. The hybrid display in the present invention has low manufacturing cost. Moreover, the weight is substantially reduced and the hybrid display is light weight.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hybrid display suitable for operating under any environmental illumination, the hybrid display comprising:
a reflective substrate having a first surface and a second surface;
a plurality of self-emissive display units arranged to form an array on the first surface of the reflective substrate; and
a plurality of reflective light valves arranged to form an array on the second surface of the reflective substrate, wherein the reflective light valves are suitable for modulating the reflectivity of ambient light.

2. The hybrid display of claim 1, wherein the self-emissive display unit comprises an electro-luminescence display unit.

3. The hybrid display of claim 1, wherein the reflective light valve comprises a liquid crystal display unit, an electro-wetting display unit or an electrophoresis display units.
